(19) United States
(12) Patent Application Publication
(10) Pub. No.: US 2011/0031051 A1
(43) Pub. Date: Feb. 10, 2011

(54) Rechargeable electric vehicle with extended driving range, and method of converting vehicle with internal combustion (IC) engine to rechargeable electric vehicle

(76) Inventor: Albert Donald George, Hattiesburg, MS (US)

Correspondence Address: SHLESINGER, ARKWRIGHT & GARVEY LLP, 5845 Richmond Highway, Suite 415, ALEXANDRIA, VA, 22303, US

(21) Appl. No.: 12/458,622

(22) Filed: Jul. 17, 2009

(51) Int. Cl. B60K 1/00; H02K 15/00

(52) U.S. Cl. 180/65.31; 29/596

(57) ABSTRACT

Electric vehicle includes a body, a rechargeable battery, an electric motor, a driven wheel, and a brake. A generator is connected to the rechargeable battery for recharging the battery. Generator includes a drive shaft for mechanically powering the generator for providing electrical energy to recharge the battery. A mechanical output is provided adjacent the wheel. A mechanical drive is provided on the generator for rotating the drive shaft of the generator. A mechanical output is adjacent the wheel. There is a mechanical clutch, and a mechanical actuator connected to brake and clutch. Mechanical clutch engages the mechanical output adjacent the wheel and engages the mechanical drive. The clutch causes mechanical output to drive the mechanical drive to rotate generator shaft to generate electrical energy when the brake is actuated and the brake actuates the mechanical actuator and causes the mechanical clutch to engage the mechanical output with the mechanical drive.

### FIELD OF THE INVENTION

The invention relates to electric vehicles. More particularly, the invention relates to rechargeable electric vehicles which are powered by an electric motor and a rechargeable battery, and which has a separate generator for recharging the vehicle battery for extending the useable driving range of the electric vehicle. Even more particularly, the invention relates to a method of converting an internal combustion (IC) engine vehicle to a rechargeable electric vehicle powered by an electric motor, a rechargeable battery, and a separate mechanically actuated generator for recharging the vehicle battery for extending the useable driving range of the electric vehicle. The invention further relates to electric vehicles powered entirely by an electric motor from a rechargeable storage battery that is capable of travelling at legally allowable highway speed and extending the useful range of the vehicle and the battery with an onboard generator for the battery.

### BACKGROUND OF THE INVENTION

The process of generating, storing, and releasing electric energy for work is known.

Further, power train systems using a power source to transfer energy to vehicle wheels is known. Further, the mechanics or process by which a power source propels wheeled vehicles is known as the power train (PT) and is substantially the same regardless of make or model, except in hybrid vehicles, and is well known to those familiar with the art. The PT is a series of mechanical connections which transfer the energy of the power source to the wheels of the vehicle. The first item in the PT of most conventional vehicles is the power source, traditionally an internal combustion engine. (ICE) Further, the use of varied ratios of planetary gears to vary the velocity and direction of the vehicle with the speed of the motor using conventional transmissions is known and in regular use. Further, the art of generating electric energy by any of several means and storing it in potential for later use as kinetic energy to do work is known.

Electric vehicles are known.

Rechargeable electric vehicles are known.

Further, hybrid vehicles are known; that is, vehicles which can be alternately powered by either an internal combustion (IC) engine or an electric motor powered by a rechargeable battery.

Conventional IC engine vehicles are likewise known.

The power transmission of a known powertrain (PT) in a known IC engine vehicle is supplied by rotating a crankshaft through a series of cams driven by a series of pistons fired by the explosion of combustible fuel in cylinders in a cast metal block. The rotating crankshaft communicates with a torque converter which connects to a variable speed transmission system connected to a differential gear system for turning, cornering and turning the wheels. The transmission system converts the ratio of the motor speed to the velocity of the vehicle through a series of planetary gears with different relative ratios. The transmission gears may be manually shifted, as in racing cars, to change the speed or reverse the direction of the vehicle, or be hydraulically shifted as in automatic shift cars. The last stage in the conventional PT connects the differential to the wheels. All this is known art familiar even to amateur mechanics.

### OBJECTS AND SUMMARY OF THE INVENTION

An object of the invention is to overcome the drawbacks of the prior art.

An object of this invention is to overcome some of the drawbacks of the present art by eliminating the need for an internal combustion engine as the primary power source in the PT.

A further object is to eliminate emission of toxic and greenhouse gases, retard the global warming of the atmosphere, and reduce the need for oil and other fossil fuels for propelling transportation vehicles.

A still further object is to reduce the need for an outside electric source to maintain the charge of the battery of electric cars as much as possible, given losses owing to friction between moving mechanical parts, for example. The invention proposes to make use of presently known art as much as possible to reduce the amount of re-tooling needed to adapt totally electric vehicles to known art.

Another object of the invention is to provide vehicle to grid (V2G) technology on an electric car.

Yet another object of the invention is to provide an even larger battery, or battery pack, than required on an electric car.

Another object of the invention is to provide a process of adapting the power transmission of a known powertrain (PT) from a known IC engine vehicle for use in driving a transportation vehicle by making use of available energy from revolving wheels of a moving vehicle. By making an electric motor the primary power source in an existing power train system able to propel a full sized totally electric vehicle at satisfactory highway speeds is new. This invention takes the process of vehicular transportation to another level by providing a different method of using energy for transportation without requiring more energy in changing the process.

Another object of the invention is to provide an electric vehicle which has a longer effective driving range between charges of the battery with an external power source than had been previously possible.

Another object of the invention is to provide an electric car which relies solely on an electric motor, a rechargeable battery, and a separate generator as a power source for driving the car, in use.

A further object of the invention is to provide a method of converting an existing conventional IC engine vehicle with a conventional powertrain into an electric vehicle with an electric motor, and using a majority of the existing components of the IC engine vehicle as a part of a rechargeable electric vehicle.

A further object of the invention is to convert an existing vehicle with a gasoline engine into a rechargeable electric vehicle by removing an existing IC engine, leaving an exchanging drivetrain in place, and replacing the IC engine with an electric motor with a differential connectable with the existing IC engine powertrain and the electric motor.

Yet another object of the invention is to provide an electric vehicle with an electric motor, and a separate generator apart from the electric motor, which is less complicated than prior art electric vehicles, which has fewer mechanical losses, and hence which has a longer effective driving range between charges of the battery with an external power source than the prior art vehicles.

A further object of the invention is to provide an electric vehicle with an electric motor, and a mechanically actuated separate generator, is less complicated than prior art electric vehicles, and which has a longer effective driving range between charges of the battery with an external power source than the prior art vehicles.

In sum, the invention includes an electric car having an electric motor, a rechargeable battery, and a mechanically actuated and driven generator as a power source for the battery.

The invention likewise includes an electric car having an electric motor, a rechargeable battery, a separate mechanically actuated and driven generator as a power source for renewing lost energy from the battery, and an electrical connector for connection to an external power source.

The invention likewise includes an electric car having an electric motor, a rechargeable battery, a separate mechanically actuated and driven generator as a power source for the battery, and a direct mechanical connection between a wheel and a generator, the mechanical connection being a connectable and disconnectable mechanical device, such as a gear system and mechanical clutch apparatus, including one or more gears or pulleys.

This invention incorporates an electric motor with sufficient power capacity to propel an ordinary passenger vehicle from full stop to such highway speed as the law allows. By orienting the axis of the motor from front to back as in current conventional internal combustion vehicles reduces the need in manufacture to redesign and retool for the vehicle by conforming it to existing power train art. This contrasts with and simplifies the complex power train design of hybrid vehicles.

This invention includes the modification of known internal combustion (IC) engine vehicles for use as in totally electric vehicles, such as by removing the IC engine, adding an electric motor in place of the removed IC engine, using the existing powertrain, and adding a sufficiently large rechargeable battery to power the electric motor for driving the vehicle.

The invention is further directed to the conversion of a conventional IC engine or ICE vehicle into an electric vehicle including an electric motor in place of a removed ICE, adding an electric motor connected to the existing ICE powertrain, and adding a rechargeable battery with sufficient capacity to power the electric motor for driving the powertrain and, hence, the vehicle at conventional speeds on public roads. This inventive electric vehicle utilizes the following:

1) Electricity can be produced in a variety of ways, as is well known, but the most common way is by rotating a coil of wires in a magnetic field. Any power source able to rotate a coil in a magnetic field generates electric energy which can be stored in potential in a storage battery as direct current. The direct current may be converted by means of a power inverter to change the direct current into alternating current to drive an electric motor. Through a series of mechanical stages known as the power train system (PTS) the electric motor drives the wheels and at the same time boosts the voltage of the battery. The rotation speed of the electric motor is regulated through a standard rheostat controlled by the driver with a foot pedal which communicates with the rheostat to vary the flow of electricity to the electric motor, the flow of electricity to the motor regulates the rotation speed of the motor which, in turn determines the speed of the vehicle;

2) By orienting the axis of the electric motor from front to back as in IC engine vehicle with the removed IC engine, and by using the linkage of the IC engine power train which remains essentially the same, then there is no need for an ICE to serve as the primary power source in a resultant totally electric vehicle. The electric motor becomes the power source for the PTS and becomes the driving part of the PTS to replace the driven crankshaft. To renew the energy lost from operating the electric motor requires a separate source of energy. Current wisdom does so with an ICE. This invention provides for using an electric motor as the power joined with the known art of an existing PTS, to drive the vehicle by energy from the battery alone.

To use the energy supplied by a battery as the primary power source for driving an electric vehicle is nothing new. By using the available energy from a rotating wheel of the vehicle in motion, this invention replaces the energy drawn from the battery used to drive the electric motor and maintains the level of energy stored in the battery.

This invention utilizes the electric energy in a battery with an existing PTS to drive the wheels of the vehicle, and uses the available energy from a rotating wheel of the vehicle in motion to rotate the armature of a generator to renew energy to the battery which supplies electric energy to an existing PTS (instead of generating such energy with an ICE.) To connect the electric motor into a known PTS may require adapting the connection between the electric motor and the transmission. This may be done directly by locating the motor so the shaft will be in physical alignment with the power train shaft at the point where the former crankshaft connected and connecting them appropriately. If necessary the connection may require a torque converter. The electric motor then becomes a part of the power train replacing the ICE as a power source. This is the significant difference.

In this invention, one or more of the of the wheels on either the front or back may be modified by extending the rim inward sufficiently to accommodate a pulley or a cog which communicates mechanically by one or more belts or cogs with a conveniently located generator having sufficient capacity to maintain the charge of the vehicle battery when the vehicle is moving, and restore, as much as physically possible, the energy lost in running the electric motor. See FIG. 1.

### Power Train

The connection between the generator and the wheel may be implemented mechanically, either directly or indirectly by pulleys and a belt or chain, and may be engaged or disengaged according to driving conditions and sensed need. Implementation may be managed by a control panel communicating with the rheostat which responds according to conditions at any given time. For example, in long relatively level cruising, as in traveling on relatively level Interstate highways, a switch on the control panel circuit may respond by alternately disconnecting and reconnecting the generator from the power train at pre-specified intervals to prevent overload. In rapid acceleration, as in passing or in climbing, pressure on the accelerator pedal will activate the rheostat to supply more electricity to the motor and connect, or-reconnect, the generator to the power train and generate more power to the battery. In slow traffic, such is at times in city driving or at frequent stops, the rheostat will allow little or zero energy to be drawn from the battery and may or may not require connecting the generator and may disconnect the generator to power the vehicle by the battery. After the vehicle has been shut down, or after long stops such as in parking, the rheostat allows zero energy to be drawn from the battery. After having been driven, the battery will have been kept as fully charged as possible, thus reducing the length of time required for recharging from an outside energy source. The battery will have been recharged as much as possible, given energy losses due to friction between moving parts, and energy losses when converting from one form of energy to another. For example, when converting from kinetic to potential energy, and taking into account rolling resistance of the tires with the road on which the vehicle travels. For initially starting the vehicle, pressing the accelerator pedal will reconnect the generator until a determined speed is reached. If desired, a cruise control device to maintain a steady velocity of the vehicle may be connected into the system using existing art.

As used herein, powertrain refers to the components which generate and deliver power to the road, and that includes the engine, transmission, driveshaft, differentials, and the final drive, including drive wheels. Relative terms such as front, back, left, and right are for convenience only and are not intended to be limiting.

### BRIEF DESCRIPTION OF THE DRAWINGS

FIG. 1 is top view of an embodiment of a rechargeable electric vehicle 10 having a mechanical system 111 for converting kinetic energy of vehicle 10 into electrical energy for charging a rechargeable battery;

FIG. 2 is a portion of the embodiment of FIG. 1 on an enlarged scale;

FIG. 3 is view similar to FIG. 2 of a further embodiment of a mechanical system 211 for converting kinetic energy of vehicle 10 into electrical energy for charging the battery; and

FIG. 4 is top view of an embodiment of a method of converting an existing conventional IC engine vehicle with a conventional powertrain into an electric vehicle 300 with an electric motor 350, and using a majority of the existing components of the IC engine vehicle powertrain 378 as a part of a rechargeable electric vehicle 300.

### DETAILED DESCRIPTION OF THE INVENTION

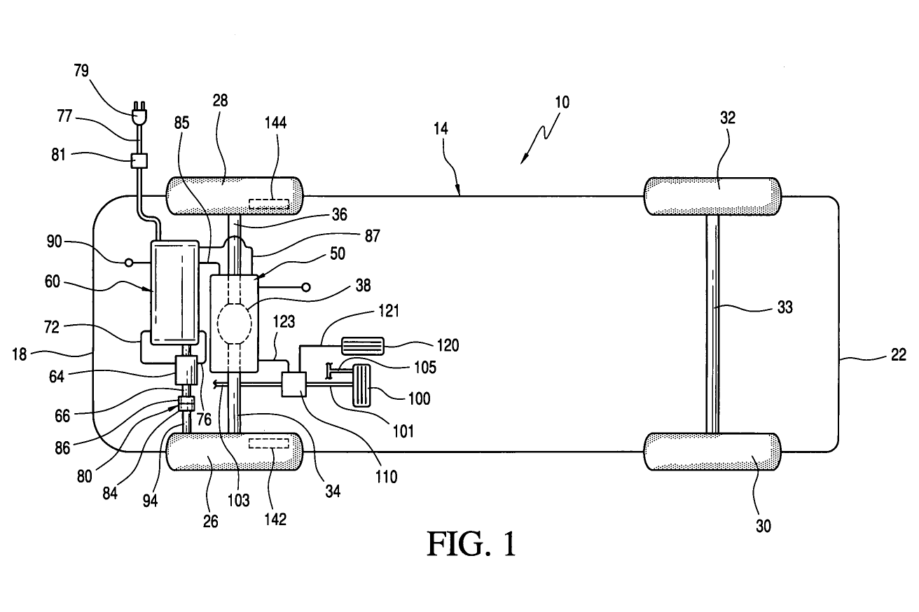

FIG. 1 illustrates an embodiment of an electric vehicle 10 according to the invention.

As shown, electric vehicle 10 may include a body 14, a front 18, and a rear 22. A left front wheel 26 and a right front wheel 28 may be provided at front 18. Likewise, a left rear wheel 30 and a right rear wheel 32 may be provided at rear 22. A rear axle 33 may be provided between left and right rear wheels 30 and 32, respectively, and may be a non-driven axle, such as a conventional non-driven rear axle used in a front wheel drive vehicle, as will be readily apparent to a person having ordinary skill in the art.

Further, a left drive shaft 34 may be provided for powering left front wheel 26, and a respective right drive shaft 36 may be provided for driving front right wheel 28. A conventional differential 38 may be provided between front wheels 26 and 28, respectively, in a conventional manner.

Differential 38 may be driven by an electric motor 50 in a conventional manner, as will be readily apparent to a person having ordinary skill in the art.

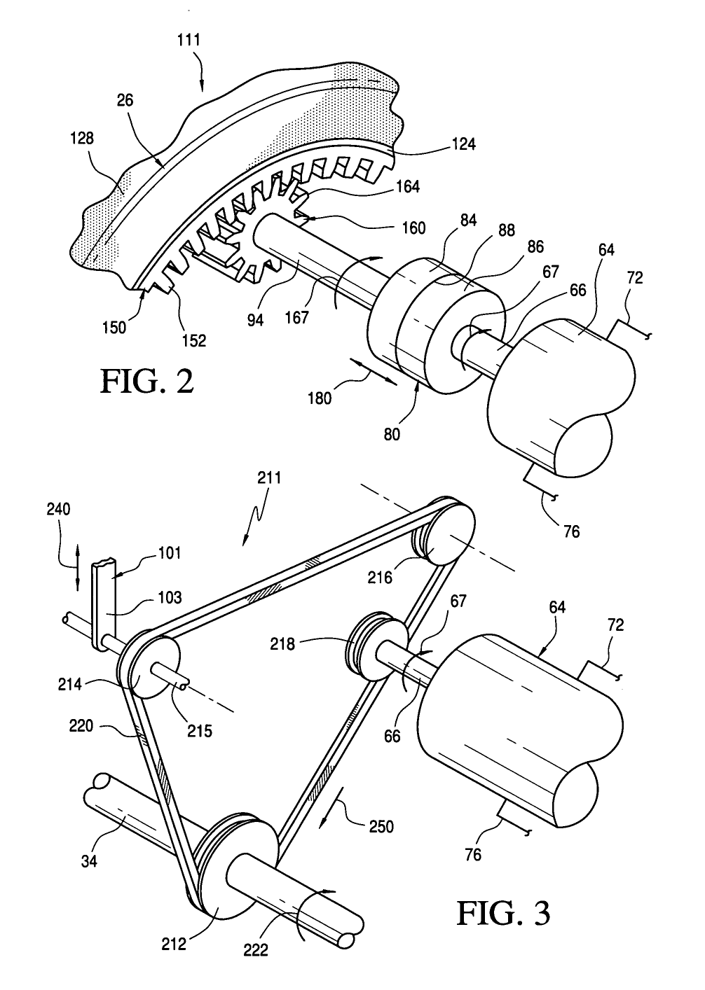

A battery 60, which may be a single rechargeable battery or an array or bank of rechargeable batteries, may be used to provide the electrical energy for powering electric motor 50, which in turn drives driven front wheels 26, 28. In order to charge battery 60, vehicle 10 may include a generator 64 having a generator shaft 66. Generator shaft 66, in turn, is driven, in use, by a mechanical clutch 80. Mechanical clutch 80 may include a driven coupling 84 and a drive coupling 86. In use, when clutch 80 is engaged, driven coupling 84 will mechanically engage drive coupling 86. In this regard, please see FIG. 2 illustrating this embodiment of mechanical clutch 80 on an enlarged scale.

Further, in use, when clutch 80 is engaged for driving generator 64 for generating electrical energy to recharge battery 60 so as to extend the driving range of electric vehicle 10, shaft 66 may be driven in a direction of rotation 67, as shown in FIG. 2. This will be described in greater detail below in connection with FIG. 2. It will be appreciated that a wire 72 and a wire 76 may be provided on generator 64 so as to direct electrical energy generated by generator 64 to rechargeable battery 60, as will be readily appreciated.

A driven shaft 94 may be provided between clutch 80 and a moving part of vehicle 10, such as a mechanical output adjacent at least one of the wheels or mechanically driven parts. Thus, as shown, driven shaft 94, for example, may be provided between left front wheel 26 and driven coupling 84 so as to impart rotary motion from wheel 26 to generator 64 for generating electrical energy under driving conditions in which kinetic energy is available for conversion to electrical energy for recharging battery 60. Such conditions include, for example, when electric vehicle 10 is slowing down, or going downhill, or when the driver has applied a brake 100 in order to slow or stop vehicle 10.

In use, there will be driving conditions in which the recharging of battery 60 by the conversion of kinetic energy to electrical energy with the described front wheel 26 generator 64, clutch 80, and associated charging components will be insufficient to recharge battery 60. Under such condition, it may be necessary to totally recharge battery 60 with an external power source, such as a conventional household power supply of 110/220 volt or a conventional 110/220 volt power source at the user's place of business or at an automobile service station, for example. Accordingly, a wire or power cable 77 for connecting rechargeable battery 60 may be provided. A plug 79 configured for mating with a 110/220 volt electrical outlet, for example, may likewise be provided on wire 77. Further, given that battery 60 may be a 12 volt DC battery, for example, a converter 81 may be provided, such as a conventional AC/DC converter for converting a 110/220 volt AC power supply to a 12 volt DC output for charging a 12 volt DC battery 60.

One or more wires 85 and 87 may be provided between battery 60 and electric motor 50 for driving motor 50, in use, as will be readily appreciated. A ground 90 may be provided for grounding one or more of the electrical components, such as battery 60, generator 64, and electric motor 50, for example, if required.

A schematically shown brake line 105 may be provided between brake pedal 100 and a brake system, as will be readily appreciated.

In addition, a control 110 may be provided for governing the operation of electric motor 50, mechanical clutch 80, accelerator 120, and brake 100. Although mechanical clutch 870 may be actuated solely with a mechanical actuator described in detail below, depending on user requirements, control 110 may be part of the control system for clutch 80.

Control 110 may be a rheostat provided for governing the operation of electric motor; that is, for changing the output speed of electric motor 50 in an infinitely adjustable manner. Control 110 may likewise include a programmable or pre-programmed electronic chip to be programmed to govern the desired operational inputs and outputs dependent on the vehicle in accordance with the invention, as will be readily appreciated.

Inasmuch as the braking force afforded by the reduction in kinetic energy resulting from the driving of mechanical coupling 80 and generator 64 by left front wheel 26 may be insufficient to sufficiently slow down or stop vehicle 10 under certain driving conditions, it is contemplated that mechanical brakes, such as the illustrated conventional disk brakes 142 and 144, may likewise be provided. Mechanical brakes, such as disk brakes or drum brakes, for example may be provided at one or more of front wheels 26, 28, and rear wheels 30, 32. further, to maximize conversion of kinetic energy to electrical energy, it is contemplated that under braking conditions in which the mechanical brakes (e.g., disk brakes 142, 144) are used, then the generator 64 may likewise remain engaged to both continue to generate electrical energy, as well as to continue to assist in the slowing of vehicle 10.

Brake line 105 may be actuated when a user, such as the operator of vehicle 10, must stop quickly. For example, when the operator of vehicle 10 depresses brake pedal 10 slightly, such as when initially slowing vehicle 10, mechanical linkage 101 causes clutch 80 to engage, and vehicle 10 is slowed thanks to the drag owing to the braking force generated by the drag on wheel 26 exerted by the generation of electrical energy by the mechanical turning of shaft 94 by wheel 26 against the counteractive force exerted by generator 64 acting on generator shaft 66 against the force of generator 64 in the process of generating electrical energy.

However, when a greater braking force is required, the operator presses down even further on brake pedal 100. In that case, the brake line 105 will be pressurized, as will be readily understood, and the disk brakes 142, 144 will be actuated and engage with the counterpart unillustrated rotors adjacent wheels 26 and 28, respectively. The mechanical brake is configured to stop the vehicle when the brake is actuated and applied more than is required for actuating the mechanical actuator and causing the mechanical clutch to engage the mechanical output with the mechanical drive.

FIG. 2 shows additional detail of vehicle 10 of FIG. 1, so that a mechanical system 111 for converting kinetic energy of vehicle 10 into electrical energy for charging battery 60 may be explained further. Mechanical system 111 is as shown in FIG. 1, on an enlarged scale, for clarity.

In order to provide mechanical input from wheel 26 to generator 64, wheel 26 may be provided with a tire 128 and a rim 124, as will be readily understood. A drive gear 150 may be provided on or adjacent wheel 26; that is, on or adjacent rim 124, as shown. Drive gear 150 may include one or more drive gear teeth 152, which are configured and provided for driving a driven gear 160 having, in turn, one or more driven gear teeth 164. As will be readily appreciated, driven gear teeth 164 may be configured to engage and mate with gear teeth 152. Gear teeth 164 and 152 may be normally engaged, as shown, or normally disengaged, depending on the manner in which clutch 80 is to be driven. As shown, and as described above, clutch 80 includes mating couplings 84 and 86 with interface 88 therebetween. Normally, when electric motor 50 is driving vehicle 10, in use, clutch 80 will be disengaged. That is, clutch 80 will normally be in its configuration so that shaft 66 of generator 64 is not being driven. Such will be the case when motor 50 is powering the wheels of vehicle 10. In that situation, the couplings 84 and 86 will be spaced apart in the direction of an arrow 180, and no power from driven shaft 94 will be imparted to drive shaft 66 in the direction of arrow 67. In the case where vehicle 10 is going downhill, or when the brakes are being applied, in use, the actuation of brake 100 will cause clutch 80 to be moved in the direction of arrow 180, so as to engage driven coupling 86 with drive coupling 84. That is the position shown in FIG. 2. In that manner, with couplings 84 and 86 engaged, the rotation of shaft 94 in direction 167 will rotate engaged couplings 84 and 86 in the same direction of arrow 167 and, hence, shaft 66 will likewise be driven in direction 67 for driving generator 64 and generating electrical energy which will be provided to battery 60 via wires 72 and 76, as will be readily appreciated.

It should be noted that the actuation of brake 100 will cause mechanical linkage 101 to actuate an end element 103 of linkage 101. For clarity, end element 103 is omitted in FIGS. 1 and 2; rather, end element 103 is shown on an enlarged scale in FIG. 3. a person having ordinary skill in the art will recognize that end element 103 may be readily mechanical moved by linkage 101 to move couplings 84, 86 into and out of engagement as shown by double-headed arrow 180.

FIG. 3 illustrates another embodiment of a mechanical apparatus 211 for driving generator 64 for charging battery 60.

Mechanical apparatus 211 may include a driven pulley 212, and one or more idler pulleys 214 and 216. A further driven pulley 218 may be provided on shaft 66 of generator 64. A V-belt 220 may be provided around pulleys 212, 214, 216, and 218, as shown, as will be readily understood. Given that pulley 212 is provided on left drive shaft 34, pulley 212 will likewise be driven by drive shaft 34 in a direction of rotation 222 of shaft 34. Further, depending on the state of vehicle 10, pulley 216 may be engaged or disengaged for tightening and loosening V-belt 220, in a known manner. That is, in the engaged position shown in FIG. 3, pulley 216 has been moved sufficiently upward (as viewed in FIG. 3) in direction of a double-headed arrow 240, so that V-belt 220 is sufficiently tensioned by end 103 of mechanical linkage 101, so that, in turn, V-belt 220 will be driven in direction of rotation 222 by drive shaft 34; thus, V-belt 220 will be driven in a direction 250, while sufficiently engaging pulley 218, so that pulley 218 is driven in direction 67 along with shaft 66. In sum, the driving of shaft 66 will cause generator 64 to generate electrical energy directed to battery 60 by one or both of wires 72 for charging battery 60 in a manner analogous to the manner in which battery 60 is charged by generator 64 in the embodiment of FIG. 2. As will have been readily appreciated, in the embodiment of FIG. 3, the battery 60 is charged by the mechanical energy of shaft 64 converting the kinetic energy of the drive shaft 34 of the slowing vehicle 10 to recharge battery 60; yet, in the embodiment of FIG. 2, the mechanical/kinetic energy of vehicle 10 is converted to electrical energy by use of the mechanical engagement with drive gear 150 on wheel 26.

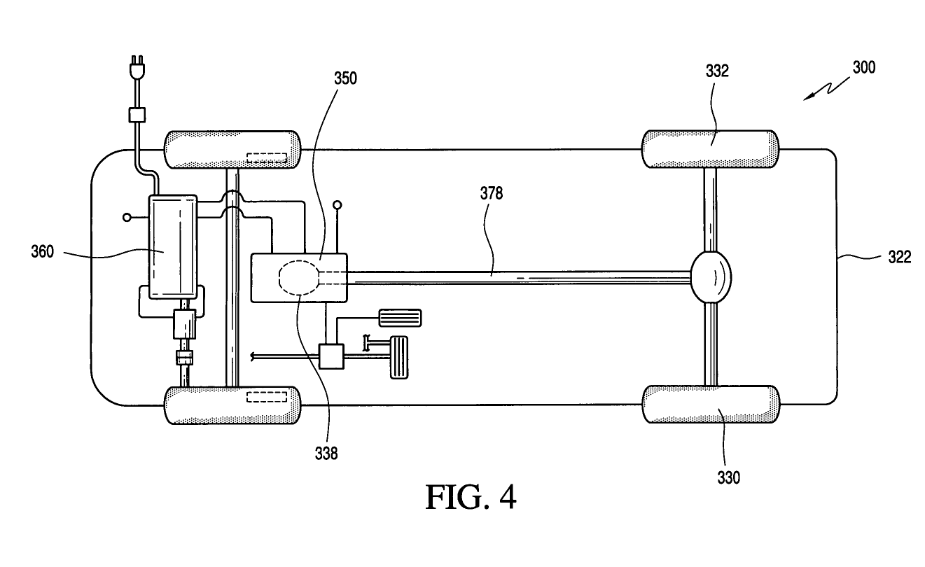

FIG. 4 illustrates an embodiment of an electric vehicle 300 with an electric motor 350 which has been made by a converting a vehicle with an existing conventional IC engine vehicle and a conventional powertrain into the illustrated rechargeable electric vehicle 300. Electric motor 350 may be provided with its longitudinal axis extending longitudinally or transversely, or perpendicularly to the longitudinal axis of vehicle 300, depending on the configuration of the powertrain 378, for example.

The method includes using a majority of existing components of the IC engine vehicle powertrain 378 as a part of a rechargeable electric vehicle 300.

More specifically, electric vehicle 300 is made by removing substantially only an existing engine of a vehicle with an IC engine, such as an automobile, and replacing the IC engine with the illustrated electric motor 350. Thus, vehicle 300 may include components from the converted IC engine vehicle, such as a rear 322 of the vehicle, a left rear wheel 330, and a right rear wheel 332. An existing, powertrain 378 may be left in place along with conventional existing components of powertrain 378, such as a drive shaft, rear differential, rear drive axle, bearings, and additional components of the conventional drive powertrain 378, as will be readily appreciated. In some conversions, it may be possible to re-use an existing differential of the conventional IC engine vehicle which has been converted to rechargeable electric vehicle 300. It is contemplated, however, that a different differential, such as a differential 338 will be substituted for the removed conventional differential of the IC engine vehicle. The illustrated differential 338 may be configured for connecting an output such as an output shaft of electric motor 350 with powertrain 378, as will be readily understood by a person having ordinary skill in the art.

Further, a rechargeable electric battery 360 may be used instead of or in addition to the battery which had been a part of the existing converted IC engine vehicle prior to conversion to the illustrated electric vehicle 300 was made by the conversion method in accordance with the invention described above.

In sum, the inventive method includes removing the existing IC engine in a conventional vehicle, substituting an electric motor 350 for the removed IC engine, adding differential 338 to couple the output of motor 350 to powertrain 378, adding rechargeable battery 360, and using as many components of the pre-conversion IC engine vehicle as possible so as to minimize conversion difficulties, and, indeed, minimize conversion costs.

It is further contemplated that the generator may be provided a rectifier to provide DC current to the battery, as will be understood. Further, an alternator may be used instead of or in addition to the generator described above.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

1. An electric vehicle, comprising:
a) a body;
b) a wheel being provided, the wheel being a driven wheel;
c) an electric motor provided;
d) a brake being provided;
e) a battery being provided, the battery being a rechargeable battery;
f) a generator being provided, the generator being operatively connected to the rechargeable battery and being sufficiently large for recharging the rechargeable battery;
g) the generator including a drive shaft for mechanically powering the generator for providing electrical energy for recharging the battery;
h) a mechanical output being provided adjacent the wheel;
i) a mechanical drive provided on the generator, the mechanical drive being configured for rotating the drive shaft on the generator;
j) the mechanical output provided adjacent the wheel being provided on the wheel;
k) a mechanical clutch being provided;
1) a mechanical actuator operatively mechanically connected to the brake and the mechanical clutch; and
m) the mechanical clutch being configured for engaging the mechanical output on the wheel and for engaging the mechanical drive for causing the mechanical output to drive the mechanical drive to cause the generator shaft to rotate for causing the generator to generate electrical energy when the brake is actuated and the brake actuates the mechanical actuator and causes the mechanical clutch to engage the mechanical output with the mechanical drive.

2. (canceled)

3. Electric vehicle as in claim 2, wherein:
a) the mechanical output includes a drive gear provided on the wheel.

4. Electric vehicle as in claim 1, wherein:
a) an axle is provided between the motor and the wheel; and
b) the mechanical output is provided on the axle.

5. Electric vehicle as in claim 1, wherein:
a) an axle is provided between the motor and the wheel; and
b) the mechanical output is the axle.

6. Electric vehicle as in claim 6, wherein:
a) the mechanical output includes a pulley provided on the axle.

7. Electric vehicle as in claim 1, wherein:
a) a mechanical brake is provided for stopping the vehicle; and
b) the mechanical brake is configured to stop the vehicle when the brake is actuated and applied more than required for actuating the mechanical actuator and causing the mechanical clutch to engage the mechanical output with the mechanical drive.

8. Electric vehicle as in claim 7, wherein:
a) the mechanical brake includes a disk brake.

9. Electric vehicle as in claim 1, wherein:
a) an axle is provided between the motor and the wheel;
b) the mechanical output is provided on the axle; and
c) the axle is a conventional axle.

10. Electric vehicle as in claim 1, wherein:
a) an accelerator is provided; and
b) a control is provided, the control is operatively connected to the accelerator, and the control includes a rheostat for governing the operation of the electric motor for changing the output speed of electric motor in an infinitely adjustable manner.

11. A method of converting a vehicle with wheels, an internal combustion (IC) engine to a rechargeable electric vehicle, the method comprising:
a) providing a vehicle with an internal combustion (IC) engine, an IC engine differential, a powertrain, and a battery;
b) removing the IC engine and the IC engine differential;
c) removing the battery;
d) adding an electric motor, the electric motor being sufficiently powerful to power the powertrain;
e) providing a differential between the electric motor and the powertrain, the differential being configured for converting the output from the electric motor to drive the powertrain;
f) adding a rechargeable battery, the rechargeable battery being sufficiently large to power the electric motor for powering the powertrain.

12. The method as in claim 11, wherein:
a) an accelerator is provided; and
b) a control is provided, the control is operatively connected to the accelerator, and the control includes a rheostat for governing the operation of the electric motor for changing the output speed of electric motor in an infinitely adjustable manner.

13. The method as in claim 11, wherein:
a) the electric motor is sufficiently large for powering the vehicle at conventional highway speeds.

14. The method as in claim 11, wherein:
a) providing an external charger for connecting the rechargeable battery to a conventional electric outlet of an electric powergrid.
